(19) United States
(12) Patent Application Publication
(10) Pub. No.: US 2017/0001497 A1
(43) Pub. Date: Jan. 5, 2017

(54) Door Assemblies Including An Engagement Member and Vehicles Incorporating The Same

(71) Applicant: Toyota Motor Engineering & Manufacturing North America, Inc., Erlanger, KY (US)

(72) Inventor: David T. Nakayama, Canton, MI (US)

(73) Assignee: Toyota Motor Engineering & Manufacturing North America, Inc., Erlanger, KY (US)

(21) Appl. No.: 14/754,852

(22) Filed: Jun. 30, 2015

(51) Int. Cl. B60J 5/04; B62D 25/04

(52) U.S. Cl. CPC B60J 5/0423; B60J 5/0468; B60J 5/0463; B62D 25/04

(57) ABSTRACT

A door assembly including a door outer panel, a door inner panel that is coupled to and positioned inboard of the door outer panel in a vehicle lateral direction, an door impact beam positioned between the door outer panel and the door inner panel, where the door impact beam extends in a vehicle longitudinal direction, and an engagement member coupled to the door impact beam, the engagement member including a shaft that extends through a hole defined by the door impact beam and that extends in the vehicle lateral direction toward the door inner panel.

### TECHNICAL FIELD

The present specification generally relates to door assemblies for a vehicle, and more particularly, door assemblies including an engagement member.

### BACKGROUND

Vehicles may be equipped with structures that absorb and direct forces and/or energy associated with an impact. The vehicle structures divert and absorb the energy associated with the impact into energy that deforms the vehicle structures. The vehicle structures may be designed to accommodate the introduction of the energy of the impact, such that the energy associated with the impact may be controllably dissipated and directed through selective and preferential deformation of the vehicle structures.

In one example, a vehicle may include a door assembly that is coupled to a pillar assembly of the vehicle. The side of the vehicle may be struck by an object or barrier in what is referred to herein as a side impact. In a side impact, the object or barrier may strike the side of the vehicle in the vehicle lateral direction, which may cause the door assembly to intrude into the cabin of the vehicle.

Accordingly, a need exists for alternative structures for directing energy associated with a side impact.

### SUMMARY

In one embodiment, a door assembly includes a door outer panel, a door inner panel that is coupled to and positioned inboard of the door outer panel in a vehicle lateral direction, a door impact beam positioned between the door outer panel and the door inner panel, where the door impact beam extends in a vehicle longitudinal direction, and an engagement member coupled to the door impact beam, the engagement member including a shaft that extends through a hole defined by the door impact beam and that extends in the vehicle lateral direction toward the door inner panel.

In another embodiment, a vehicle includes a body including a forward pillar assembly and a rearward pillar assembly, the rearward pillar assembly includes a pillar outer panel, a pillar inner panel coupled to and positioned inboard of the pillar outer panel in a vehicle lateral direction, a door assembly coupled to the forward pillar assembly, the door assembly including a door outer panel, a door inner panel that is coupled to and positioned inboard of the door outer panel in the vehicle lateral direction, and an engagement member is positioned between the door inner panel and the door outer panel, where the engagement member is aligned with the pillar outer panel and the pillar inner panel in the vehicle longitudinal direction and at least a portion of the engagement member extends in the vehicle lateral direction toward the door inner panel.

In yet another embodiment, a method of inhibiting movement of a door assembly with respect to a rearward pillar assembly includes providing an engagement member positioned between the door outer panel and the door inner panel in a vehicle lateral direction and positioning the engagement member such that when the engagement member translates inboard in the vehicle lateral direction, the engagement member pierces the door inner panel and a pillar outer panel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle including a front door assembly and a rear door assembly according to one or more embodiments shown or described herein;

FIG. 2 schematically depicts a side view of the front door assembly and the rear door assembly of FIG. 1 including a door impact beam according to one or more embodiments shown or described herein;

FIG. 3 schematically depicts a perspective view of a door impact beam according to one or more embodiments shown or described herein;

FIG. 4 schematically depicts a section view of the door impact beam of FIG. 3 positioned within one of the front and rear door assemblies of FIG. 2 according to one or more embodiments shown or described herein;

FIG. 5 schematically depicts a section view the door impact beam and one the front and rear door assemblies of FIG. 4 during a side impact according to one or more embodiments shown or described herein;

FIG. 6 schematically depicts a perspective view of another door impact beam according to one or more embodiments shown or described herein;

FIG. 7 schematically depicts a section view of the door impact beam of FIG. 6 positioned within one of the front and rear door assemblies of FIG. 2 according to one or more embodiments shown or described herein; and

FIG. 8 schematically depicts a section view of the door impact beam and one of the front and rear door assemblies of FIG. 7 during a side impact according to one or more embodiments shown or described herein.

### DETAILED DESCRIPTION

Door assemblies and vehicles including door assemblies are disclosed herein. In one embodiment, a door assembly includes a door outer panel, a door inner panel that is coupled to and positioned inboard of the door outer panel in a vehicle lateral direction, an impact beam positioned between and coupled to at least one of the door outer panel and the door inner panel, and an engagement member coupled to the impact beam. The engagement member may include a shaft that extends through a hole defined by the impact beam and that extends in the vehicle lateral direction. The door assembly may be coupled to a forward pillar assembly and the engagement member is aligned with a pillar outer panel and a pillar inner panel of a rearward pillar assembly in a vehicle longitudinal direction. During a side impact, energy and/or forces associated with the impact cause the door outer panel, the door inner panel, and the engagement member to translate inboard in the vehicle lateral direction and cause the engagement member to pierce the door inner panel and the pillar outer panel. By piercing the pillar outer panel, the engagement member may impede intrusion of the door assembly into a passenger cabin of the vehicle during a side impact. Further, as the engagement member is initially positioned between the door outer panel and the door inner panel, the engagement member may not be visible from the exterior of the vehicle during ordinary vehicle operating conditions. Various embodiments of door assemblies are described in detail below with reference to the appended drawings.

As used herein, the term “vehicle longitudinal direction” refers to the forward-rearward direction of the vehicle (i.e., in the +/−vehicle X-direction as depicted). The term “vehicle lateral direction” refers to the cross-vehicle direction of the vehicle (i.e., in the +/−vehicle Y-direction as depicted), and is transverse to the vehicle longitudinal direction. The term “vehicle vertical direction” refers to the upward-downward direction of the vehicle (i.e., in the +/−vehicle Z-direction as depicted). Further, the terms “inboard” and “outboard” are used to describe the relative positioning of various components of the vehicle. The term “outboard” as used herein refers to the relative location of a component in direction 12 with respect to a vehicle centerline 10. The term “inboard” as used herein refers to the relative location of a component in direction 14 with respect to the vehicle centerline 10. Because the vehicle 100 may be generally symmetrical about the vehicle centerline 10, the terms “inboard” and “outboard” may be switched when evaluating components positioned along opposite sides of the vehicle 100. Further, while certain components of the vehicle 100 are described as extending in one of the identified directions or oriented toward one of the identified directions, it should be understood that these components extend or are oriented in at least these recited directions.

Motor vehicles that incorporate elements according to the present disclosure may include a variety of construction methodologies that are conventionally known, including the unibody construction methodology as depicted, as well as a body-on-frame construction methodology. While the embodiments of the present disclosure are described and depicted herein in reference to unibody structures, it should be understood that vehicles that are constructed with body-on-frame construction may incorporate the elements that are shown and described herein.

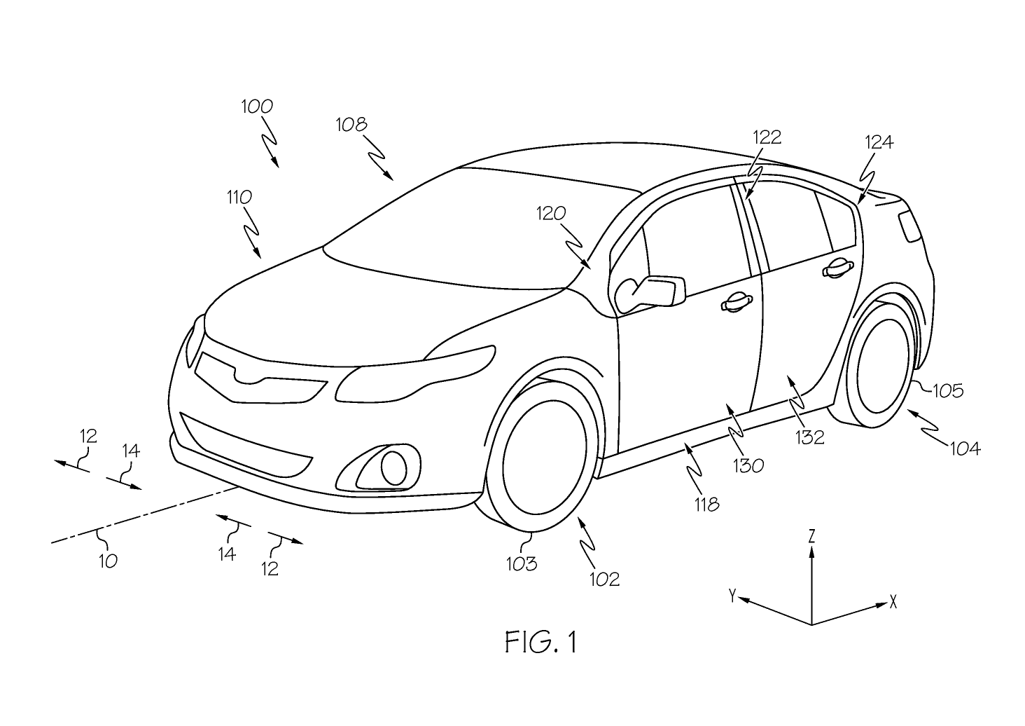

Referring to FIG. 1, a vehicle 100 is depicted. The vehicle 100 includes a body 110 onto which a vehicle drivetrain is coupled. The vehicle 100 also includes a cabin 108 that is integral with the body 110. The cabin 108 generally defines a passenger cabin of the vehicle 100.

The body 110 includes a rocker support 118 that extends in the vehicle longitudinal direction between a front suspension unit 102 and a rear suspension unit 104. The front suspension unit 102 and the rear suspension unit 104 include various components that connect a front tire 103 and a rear tire 105 to the body 110.

The body 110 includes an A-pillar 120, a B-pillar 122, and a C-pillar 124 that extend upward from the rocker support 118 in the vehicle vertical direction. The A-pillar 120 is positioned forward of the B-pillar 122 and the B-pillar 122 is positioned forward of the C-pillar 124. Other bodies may include additional pillars, such as a D-pillar and E-pillar. As used herein the terms “forward pillar assembly” and “rearward pillar assembly” are used to refer to the relative location of the A-pillar 120, B-pillar 122, and the C-pillar 124 with respect to one another. For example, in one embodiment, the A-pillar 120 is a forward pillar assembly and the B-pillar 122 is a rearward pillar assembly that is positioned rearward of the forward pillar assembly in the vehicle longitudinal direction. In embodiments, the B-pillar 122 can be the forward pillar assembly and the C-pillar 124 can be the rearward pillar assembly that is positioned rearward of the forward pillar assembly in the vehicle longitudinal direction.

The vehicle 100 includes one or more door assemblies coupled to the body 110 of the vehicle 100. A front door assembly 130 is coupled to the A-pillar 120 and a rear door assembly 132 is coupled to the B-pillar 122. In some embodiments, the front door assembly 130 is hingedly coupled to the A-pillar 120 and the rear door assembly 132 is hingedly coupled to the B-pillar 122. In other embodiments, the rear door assembly 132 may be severally coupled to the B-pillar 122, such as when the rear door assembly 132 is sliding door or when the rear door assembly 132 is hingedly coupled to the C-pillar 124 (i.e., a rear-hinged door). The front door assembly 130 and the rear door assembly 132 facilitate ingress and egress to the cabin 108 of the vehicle 100.

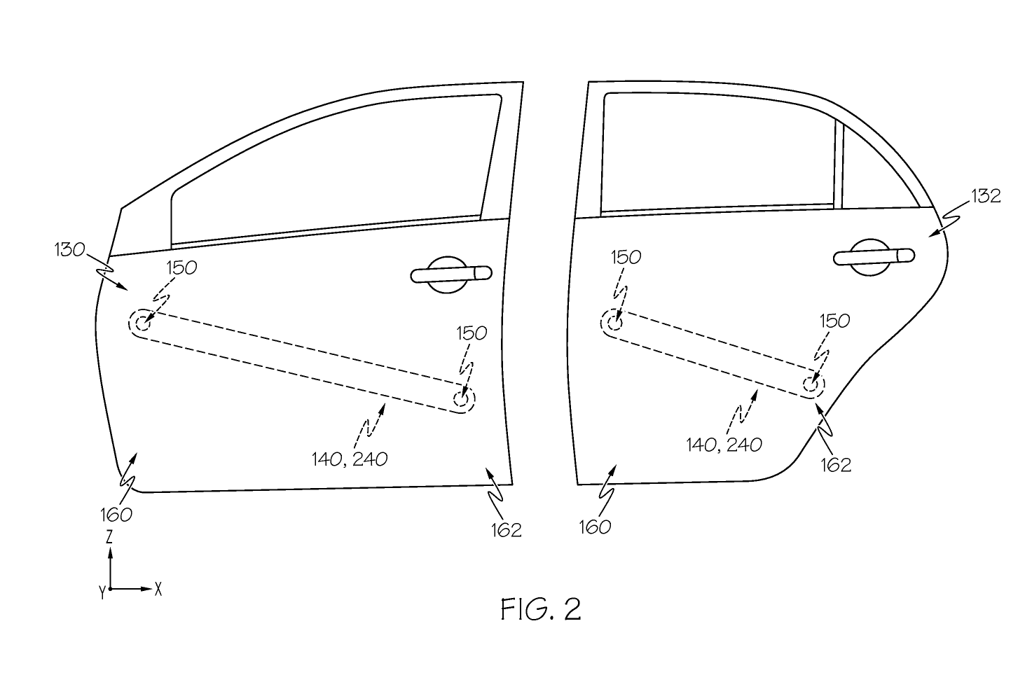

Referring to FIG. 2, the front door assembly 130 and/or the rear door assembly 132 include an door impact beam 140 positioned within each of the front door assembly 130 and/or the rear door assembly 132. The door impact beams 140 extend in the vehicle longitudinal direction within the front door assembly 130 and the rear door assembly 132. Each of the door impact beams 140 increases the strength and/or the stiffness of the front door assembly 130 and/or the rear door assembly 132.

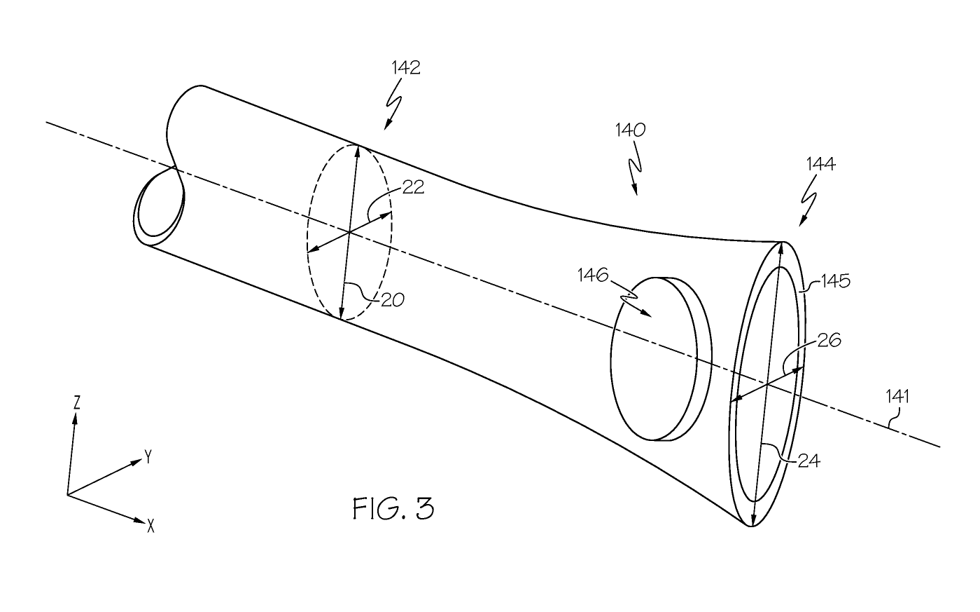

Referring to FIG. 3, in one embodiment, the door impact beams 140 have a generally circular or elliptical cross-section. In particular, the door impact beams 140 may include a generally hollow structure with an enclosed cross-section. The door impact beam 140 includes a central portion 142 and an end portion 144 that is positioned proximate to an end surface 145 of the door impact beam 140. The door impact beam 140 includes an impact beam centerline 141 that bisects the door impact beam 140 in the vehicle lateral direction and the vehicle vertical direction. The door impact beam 140 has a central beam height 20 evaluated in the vehicle vertical direction at the central portion 142 and a central beam width 22 evaluated in the vehicle lateral direction at the central portion 142. The door impact beam 140 has an end beam height 24 evaluated in the vehicle vertical direction at the end portion 144 and an end beam width 26 evaluated in the vehicle lateral direction at the end portion 144. The end beam height 24 at the end portion 144 is greater than the central beam height 20 at the central portion 142 such that the end portion 144 of the door impact beam 140 flares outward, thereby increasing in dimension in the vehicle vertical direction along a length of the door impact beam 140 toward the end portion 144. The end beam width 26 at the end portion 144 is less than the central beam width 22 at the central portion 142 such that the end portion 144 of the door impact beam 140 tapers inward, thereby decreasing in dimension along a length of the door impact beam 140 in the vehicle lateral direction toward the end portion 144. By flaring outward in the vehicle vertical direction and tapering inward in the vehicle lateral direction, the strength and/or stiffness of the door impact beam 140 evaluated in the vehicle lateral direction at the end portion 144 may be less than the strength and/or stiffness of the door impact beam 140 at the central portion 142. By reducing the strength and/or stiffness of the door impact beam 140 at the end portion 144 in the vehicle lateral direction, the door impact beam 140 may selectively deform at the end portion 144 during a side impact, as will be described in greater detail herein.

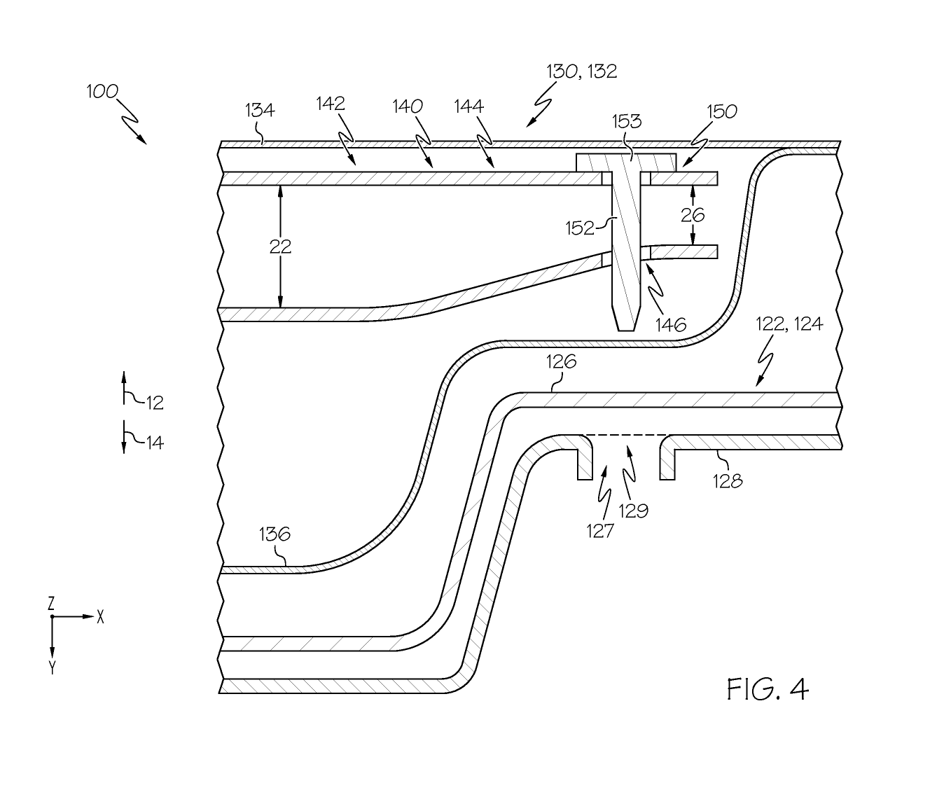

Referring to FIG. 4, the door impact beam 140 is positioned within the front door assembly 130 and/or the rear door assembly 132 of the vehicle 100. The end portion 144 of the door impact beam 140 is positioned such that at least a portion of the end portion 144 of the door impact beam 140 overlaps the B-pillar 122 and/or the C-pillar 124 in the vehicle longitudinal direction depending on the door assembly. In particular, in embodiments where the door impact beam 140 positioned within the front door assembly 130, the door impact beam 140 is positioned such that at least a portion of the end portion 144 overlaps the A-pillar 120 and/or the B-pillar 122 in the vehicle longitudinal direction. In embodiments where the door impact beam 140 is positioned within the rear door assembly 132, the door impact beam 140 is positioned such that at least a portion of the end portion 144 overlaps the B-pillar 122 and/or the C-pillar 124 in the vehicle longitudinal direction.

The front door assembly 130 and/or the rear door assembly 132 include a door outer panel 134 that is coupled to and positioned outboard of a door inner panel 136 in the vehicle lateral direction. The door impact beam 140 is positioned between the door outer panel 134 and the door inner panel 136 in the vehicle lateral direction and is coupled to at least one of the door outer panel 134 or the door inner panel 136 of the front door assembly 130 and/or the rear door assembly 132. The door impact beam 140 may be solely coupled to the door outer panel 134 or the door inner panel 136, or may be coupled to both the door outer panel 134 and the door inner panel 136.

The A-pillar, 120, the B-pillar 122 and/or the C-pillar 124 include a pillar outer panel 126 and a pillar inner panel 128 that is coupled to and positioned inboard of the pillar outer panel 126 in the vehicle lateral direction. The pillar inner panel 128 includes a reduced thickness region 127. The reduced thickness region 127 includes an aperture 129 through the pillar inner panel 128. A plug (not depicted) may be positioned within the aperture 129 to seal and/or prevent moisture from collecting between the pillar inner panel 128 and the pillar outer panel 126. In some embodiments, the pillar inner panel 128 may alternatively or additionally include a decreased material thickness at the reduced thickness region 127 and/or a plurality of holes at the reduced thickness region 127. In either instance, the reduced thickness region 127 has a locally reduced strength and/or stiffness as compared to regions of the pillar inner panel 128 that are positioned outside of the reduced thickness region 127. By locally reducing the strength and/or stiffness at the reduced thickness region 127, the reduced thickness region 127 may selectively deform during a side impact, as will be described in greater detail herein.

The door impact beam 140 includes an engagement member 150 that is coupled to the end portion 144 of the door impact beam 140. At least a portion of the engagement member 150 extends in the vehicle lateral direction toward the door inner panel 136. In the embodiment depicted in FIG. 4, the engagement member 150 includes a pin member including a shaft 152 that extends through a hole 146 defined by the door impact beam 140 and an enlarged head 153 that may impede passage of the shaft 152 completely through the hole 146. The shaft 152 is oriented to extend in the vehicle lateral direction. In some embodiments, the shaft 152 may be oriented to extend only partially in the vehicle lateral direction and may also extend forward or rearward in the vehicle longitudinal direction and/or upward or downward in the vehicle vertical direction, for example depending on the shape of the hole 146.

Referring to FIG. 2, the engagement member 150 is positioned at a rear portion 162 of the front door assembly 130 and/or the rear door assembly 132. The engagement member 150 may additionally or alternatively be positioned at a front portion 160 of the front door assembly 130 and/or the rear door assembly 132.

Referring again to FIG. 4, the engagement member 150 is coupled to the end portion 144, at least a portion of the engagement member 150 overlaps the A-pillar 120, the B-pillar 122 and/or the C-pillar 124 and is aligned with the pillar outer panel 126 and the pillar inner panel 128 in the vehicle longitudinal direction. The engagement member 150 is aligned with the reduced thickness region 127 of the pillar inner panel 128 in the vehicle longitudinal direction. The engagement member 150 may also be aligned with the reduced thickness region 127 in the vehicle vertical direction.

When a vehicle is involved in an impact, vehicle structures may elastically and plastically deform to absorb energy. The vehicle structures divert and absorb the energy associated with the impact into energy that deforms the vehicle structures. The vehicle structures may be designed to accommodate the introduction of the energy of the impact, such that the energy associated with the impact may be controllably dissipated and directed through selective and preferential deformation of the vehicle structures. The side of the vehicle may be struck by an object or barrier in what is referred to herein as a side impact. In a side impact, the object or barrier may strike the side of the vehicle in the vehicle lateral direction.

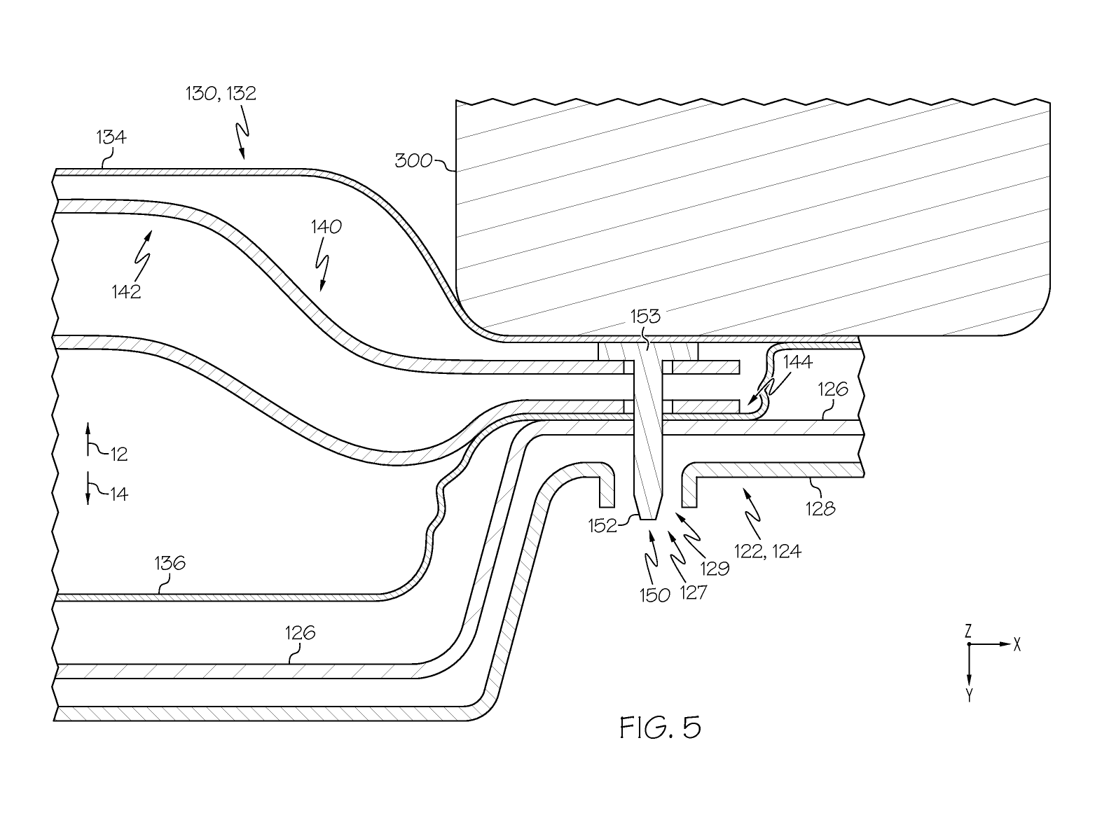

Referring to FIG. 5, a side impact with a barrier 300 is depicted. The barrier 300 impacts the front door assembly 130 and/or the rear door assembly 132 in the vehicle lateral direction. Energy and/or forces associated with the impact cause the door outer panel 134 of the front door assembly 130 and/or the rear door assembly 132 to deform and translate inboard in the vehicle lateral direction. As the door inner panel 136 is coupled to the door outer panel 134 and the door impact beam 140 is coupled to at least one of the door outer panel 134 and the door inner panel 136, the door inner panel 136 and the door impact beam 140 translate inboard in the vehicle lateral direction with the door outer panel 134. Further, as the engagement member 150 is coupled to the door impact beam 140, the engagement member 150 translates inboard in the vehicle lateral direction with the door impact beam 140.

The door outer panel 134, the door inner panel 136, and the door impact beam 140 may translate inboard in the vehicle lateral direction until the door inner panel 136 contacts the pillar outer panel 126 of the A-pillar 120, the B-pillar 122 and/or the C-pillar 124. When the door inner panel 136 contacts the pillar outer panel 126, forces and/or energy associated with the impact may cause the door inner panel 136 to deform. The door outer panel 134, the door impact beam 140, and the engagement member 150 may continue to translate inboard in the vehicle lateral direction. The end portion 144 and the engagement member 150 of the door impact beam 140 continue to translate inboard in the vehicle lateral direction, and the end portion 144 and the engagement member 150 may contact the door inner panel 136.

When the door impact beam 140 contacts the door inner panel 136, forces and/or energy associated with the impact cause the door impact beam 140 to plastically and elastically deform. As described above, the end portion 144 of the door impact beam 140 may have lower strength and/or stiffness evaluated in the vehicle lateral direction as compared to the central portion 142 of the door impact beam 140. Accordingly, the end portion 144 of the door impact beam 140 may selectively deform upon contact with the door inner panel 136.

As the end portion 144 and/or the engagement member 150 of the impact beam selectively deforms, the door outer panel 134 and the engagement member 150 may continue to translate inboard in the vehicle lateral direction. The engagement member 150 may pierce through the door inner panel 136, the pillar outer panel 126, and through the reduced thickness region 127 of the pillar inner panel 128. In the embodiment shown in FIG. 5, the reduced thickness region 127 includes the aperture 129 such that the shaft 152 of the engagement member 150 may freely pass through the reduced thickness region 127 of the pillar inner panel 128. In embodiments that include a reduced thickness region 127 including a decreased material thickness and/or a plurality of holes at the reduced thickness region 127, the reduced strength and/or stiffness at the reduced thickness region 127 may allow the engagement member 150 to preferentially pierce the reduced thickness region 127 of the pillar inner panel 128.

Once the shaft 152 of the engagement member 150 has pierced through the pillar outer panel 126 and the pillar inner panel 128, the engagement member 150 forms a mechanical connection between the front door assembly 130 and the B-pillar 122 and/or the rear door assembly 132 and the C-pillar 124. In particular, by piercing the pillar outer panel 126 and the pillar inner panel 128, mechanical interference between the engagement member 150 and the pillar outer panel 126 and/or the pillar inner panel 128 may restrict movement of the engagement member 150 with respect to the B-pillar 122 and/or the C-pillar 124. As the engagement member 150 is coupled to the door impact beam 140, which is coupled to at least one of the door outer panel 134 and the door inner panel 136, the mechanical interference between the engagement member 150 and the pillar outer panel 126 and/or the pillar inner panel 128 may restrict movement of the front door assembly 130 with respect to the B-pillar 122 and/or the rear door assembly 132 with respect to the C-pillar 124. In particular, the mechanical connection between the engagement member 150 and the pillar outer panel 126 and the pillar inner panel 128 forms a connection between the front portion 160 and/or the rear portion 162 of the front door assembly 130 with the A-pillar 120 and/or the B-pillar 122, respectively. Similarly, the engagement member 150 may form a mechanical connection between the front portion 160 and/or the rear portion 162 of the rear door assembly 132 with the B-pillar 122 and/or the C-pillar 124, respectively. In this way, both the front portion 160 and the rear portion 162 of each of the front door assembly 130 and the rear door assembly 132 are mechanically connected to the body 110 of the vehicle 100.

By restricting movement of the front door assembly 130 with respect to the B-pillar 122 and/or the rear door assembly 132 with respect to the C-pillar 124, inboard intrusion of the front door assembly 130 and/or the rear door assembly 132 into the cabin 108 (FIG. 1) during the impact is restricted. By restricting intrusion of the front door assembly 130 and/or the rear door assembly 132 into the cabin 108 during the impact, energy and/or forces associated with the side impact may be absorbed and distributed throughout the body 110 of the vehicle 100 around the cabin 108.

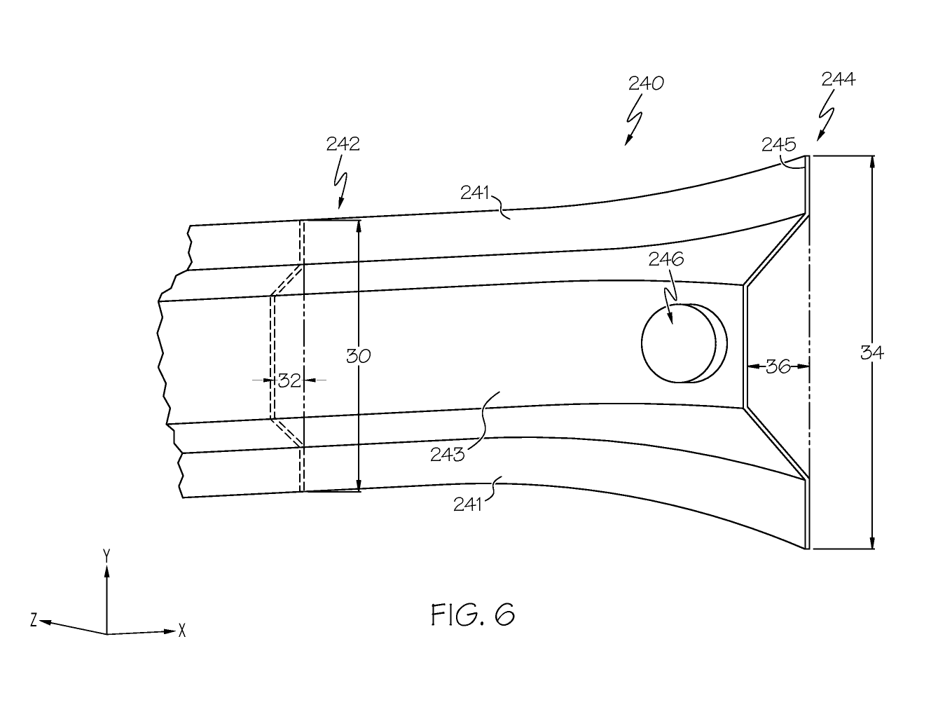

Referring to FIG. 6, another embodiment of a door impact beam 240 is depicted. Similar to the embodiment described and depicted in FIG. 3, the door impact beam 240 includes a central portion 242 and an end portion 244 that is positioned proximate to an end surface 245 of the door impact beam 240. The door impact beam 240 includes a generally hat-shaped cross section including a pair of side flanges 241 and a central flange 243 that is spaced apart from the side flanges 241. In particular, the central flange 243 may be positioned inboard or outboard of the side flanges 241 in the vehicle lateral direction and the side flanges 241 may be positioned above and below the central flange 243 in the vehicle vertical direction. The central flange 243 is spaced apart from the side flanges 241 by a central beam width 32 evaluated in the vehicle lateral direction at the central portion 242. The door impact beam 240 has a central beam height 30 evaluated in the vehicle vertical direction at the central portion 242. The central flange 243 is spaced apart from the side flanges 241 by an end beam width 36 evaluated in the vehicle lateral direction at the end portion 244. The door impact beam 240 has an end beam height 34 evaluated in the vehicle vertical direction. The end beam height 34 at the end portion 244 is greater than the central beam height 30 at the central portion 242 such that the door impact beam 240 flares outward, thereby increasing in dimension in the vehicle vertical direction along a length of the door impact beam 240 toward the end portion 244. Additionally, the end beam width 36 at the end portion 244 may be less than the central beam width 32 at the central portion 242 such that the door impact beam 240 tapers inward, thereby decreasing in dimension in the vehicle lateral direction along a length of the door impact beam 240 toward the end portion 244. By flaring outward in the vehicle vertical direction and/or tapering inward in the vehicle lateral direction at the end portion 244, the door impact beam 240 may have a reduced strength and/or stiffness evaluated in the vehicle lateral direction at the end portion 244 as compared to the central portion 242. By reducing the strength and/or stiffness of the door impact beam 240 at the end portion 244 in the vehicle lateral direction, the door impact beam 240 may selectively deform a the end portion 244 during a side impact, as will be described in greater detail herein.

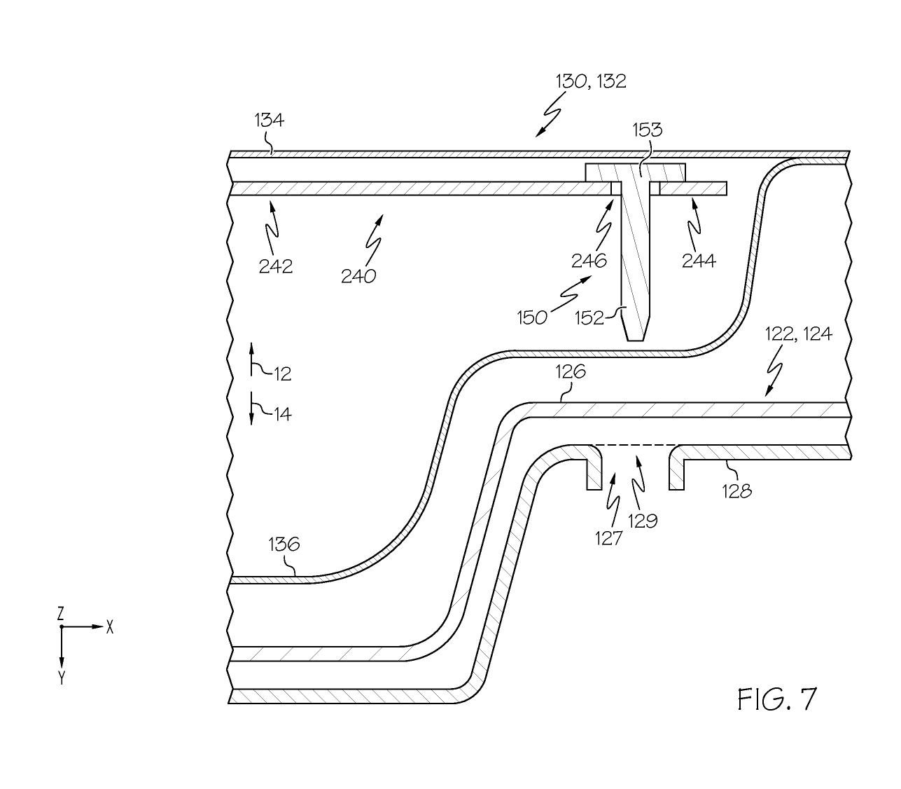

Referring to FIG. 7, the door impact beam 240 is positioned within the front door assembly 130 and/or the rear door assembly 132 of the vehicle 100. The end portion 244 of the door impact beam 240 is positioned such that at least a portion of the end portion 244 of the door impact beam 240 overlaps the A-pillar 120, the B-pillar 122, and/or the C-pillar 124 in the vehicle longitudinal direction depending on the door assembly. In particular, in embodiments where the door impact beam 240 positioned within the front door assembly 130, the door impact beam 240 is positioned such that at least a portion of the end portion 244 overlaps the A-pillar 120 and/or the B-pillar 122 in the vehicle longitudinal direction. In embodiments where the door impact beam 240 is positioned within the rear door assembly 132, the door impact beam 240 is positioned such that at least a portion of the end portion 244 overlaps the B-pillar 122 and/or the C-pillar 124 in the vehicle longitudinal direction.

As described above with respect to FIG. 5, the front door assembly 130 and/or the rear door assembly 132 include the door outer panel 134 that is coupled to and positioned outboard of the door inner panel 136 in the vehicle lateral direction. The door impact beam 240 is positioned between the door outer panel 134 and the door inner panel 136 in the vehicle lateral direction and is coupled to at least one of the door outer panel 134 or the door inner panel 136 of the front door assembly 130 and/or the rear door assembly 132. Alternatively, the door impact beam 240 is coupled to the door outer panel 134. In another embodiment, the door impact beam 240 is coupled to the door inner panel 136.

The A-pillar 120, the B-pillar 122, and/or the C-pillar 124 include the pillar outer panel 126 and a pillar inner panel 128 that is coupled to and positioned inboard of the pillar outer panel 126 in the vehicle lateral direction. The pillar inner panel 128 includes the reduced thickness region 127. The reduced thickness region 127 includes the aperture 129 through the pillar inner panel 128. A plug (not depicted) may be positioned within the aperture 129 to seal and/or prevent moisture from collecting between the pillar inner panel 128 and the pillar outer panel 126. In some embodiments, the pillar inner panel 128 may alternatively or additionally include the decreased material thickness at the reduced thickness region 127 and/or the plurality of holes at the reduced thickness region 127. In either instance, the reduced thickness region 127 has a locally reduced strength and/or stiffness as compared to regions of the pillar inner panel 128 that are positioned outside of the reduced thickness region 127. By locally reducing the strength and/or stiffness at the reduced thickness region 127, the reduced thickness region 127 may selectively deform during a side impact, as will be described in greater detail herein and/or upward or downward in the vehicle vertical direction.

The door impact beam 240 includes the engagement member 150 that is coupled to the end portion 244 of the door impact beam 240. As described above with respect to FIG. 4, at least a portion of the engagement member 150 extends in the vehicle lateral direction toward the door inner panel 136. Further, as described above with respect to FIG. 2, the engagement member 150 is positioned at a rear portion 162 of the front door assembly 130 and/or the rear door assembly 132, opposite of the front portion 160. The engagement member 150 may include the pin member including the shaft 152 that extends through a hole 146 defined by the door impact beam 240 and the enlarged head 153 that impedes passage of the shaft 152 completely through the hole 146. In the embodiment depicted in FIG. 4, the shaft 152 is oriented to extend in the vehicle lateral direction. In some embodiments, the shaft 152 may be oriented to extend only partially in the vehicle lateral direction and may also extend forward or rearward in the vehicle longitudinal direction, for example, depending on the shape of the hole 146.

As the engagement member 150 is coupled to the end portion 244, at least a portion of the engagement member 150 overlaps the B-pillar 122 and/or the C-pillar 124 and is aligned with the pillar outer panel 126 and the pillar inner panel 128 in the vehicle longitudinal direction. The engagement member 150 is aligned with the reduced thickness region 127 of the pillar inner panel 128 in the vehicle longitudinal direction. The engagement member 150 may also be aligned with the reduced thickness region 127 in the vehicle vertical direction.

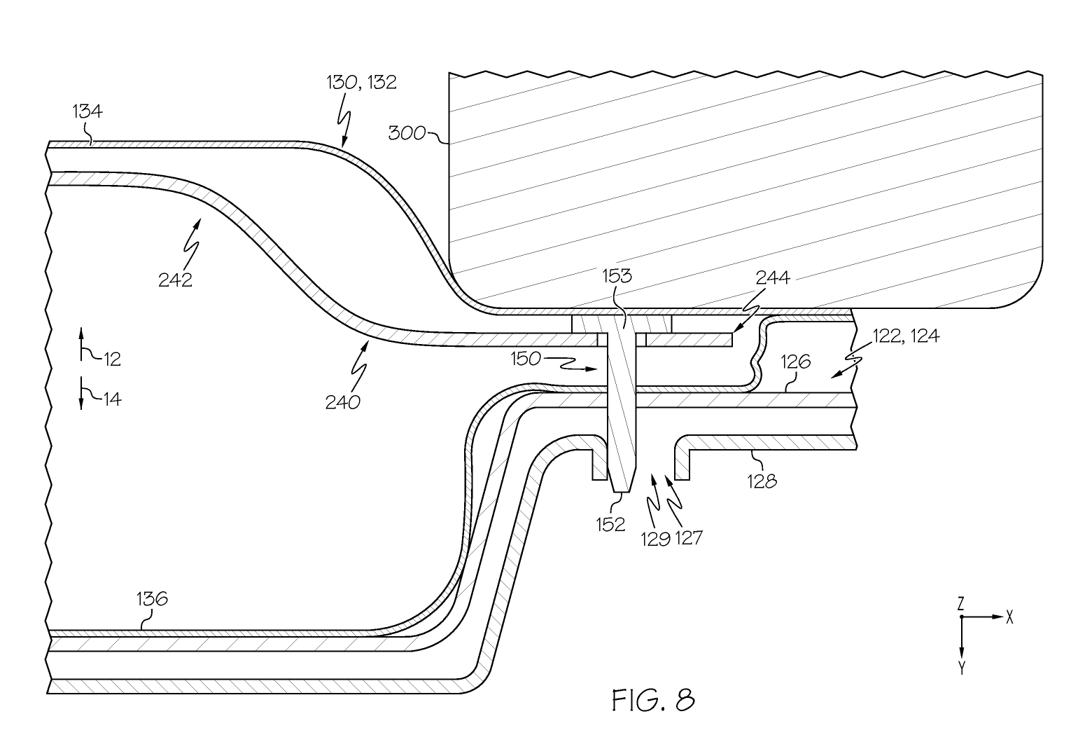

Referring to FIG. 8, a side impact with the barrier 300 is depicted. The barrier 300 impacts the front door assembly 130 and/or the rear door assembly 132 in the vehicle lateral direction. Energy and/or forces associated with the impact cause the door outer panel 134 of the front door assembly 130 and/or the rear door assembly 132 to deform and translate inboard in the vehicle lateral direction. As the door inner panel 136 is coupled to the door outer panel 134 and the door impact beam 240 is coupled to at least one of the door outer panel 134 or the door inner panel 136, the door inner panel 136 and the door impact beam 240 translate inboard in the vehicle lateral direction with the door outer panel 134. Further, as the engagement member 150 is coupled to the door impact beam 240, the engagement member 150 translates inboard in the vehicle lateral direction with the door impact beam 240.

The door outer panel 134, the door inner panel 136, and the door impact beam 240 may translate inboard in the vehicle lateral direction until the door inner panel 136 contacts the pillar outer panel 126 of the B-pillar 122 and/or the C-pillar 124. When the door inner panel 136 contacts the pillar outer panel 126, forces and/or energy associated with the impact may cause the door inner panel 136 to deform. The door outer panel 134, the door impact beam 240, and the engagement member 150 may continue to translate inboard in the vehicle lateral direction. The end portion 244 of the door impact beam 240 continues to translate inboard in the vehicle lateral direction, and the end portion 244 and the engagement member 150 may contact the door inner panel 136.

When the door impact beam 240 and/or the engagement member 150 contacts the door inner panel 136, forces and/or energy associated with the impact cause the door impact beam 240 to plastically and elastically deform. As described above, the end portion 244 of the door impact beam 240 may have lower strength and/or stiffness evaluated in the vehicle lateral direction as compared to the central portion 242 of the door impact beam 240. Accordingly, the end portion 244 of the door impact beam 240 may selectively deform upon contact with the door inner panel 136.

As the end portion 244 of the impact beam selectively deforms, the door outer panel 134 and the engagement member 150 may continue to translate inboard in the vehicle lateral direction. The shaft 152 of the engagement member 150 may pierce through the door inner panel 136, the pillar outer panel 126, through the reduced thickness region 127 of the pillar inner panel 128. In the embodiment shown in FIG. 8, the reduced thickness region 127 includes the aperture 129 such that the engagement member 150 may freely pass through the reduced thickness region 127 of the pillar inner panel 128. In embodiments that include a reduced thickness region 127 including a decreased material thickness and/or a plurality of holes at the reduced thickness region 127, the reduced strength and/or stiffness at the reduced thickness region 127 may allow the shaft 152 of the engagement member 150 to preferentially pierce the reduced thickness region 127 of the pillar inner panel 128.

Once the shaft 152 of the engagement member 150 has pierced through the pillar outer panel 126 and the pillar inner panel 128, the engagement member 150 forms a mechanical connection between the front door assembly 130 and the B-pillar 122 and/or the rear door and the C-pillar 124. In particular, by piercing the pillar outer panel 126 and the pillar inner panel 128, mechanical interference between the engagement member 150 and the pillar outer panel 126 and/or the pillar inner panel 128 may restrict movement of the engagement member 150 with respect to the B-pillar 122 and/or the C-pillar 124. As the engagement member 150 is coupled to the door impact beam 240, which is coupled to at least one of the door outer panel 134 and the door inner panel 136, the mechanical interference between the engagement member 150 and the pillar outer panel 126 and/or the pillar inner panel 128 may restrict movement of the front door assembly 130 with respect to the B-pillar 122 and/or the rear door assembly 132 with respect to the C-pillar 124. In particular, the mechanical connection between the engagement member 150 and the pillar outer panel 126 and the pillar inner panel 128 forms a connection between the front portion 160 and/or the rear portion 162 of the front door assembly 130 with the A-pillar 120 and/or the B-pillar 122, respectively. Similarly, the engagement member 150 may form a mechanical connection between the front portion 160 and/or the rear portion 162 of the rear door assembly 132 with the B-pillar 122 and/or the C-pillar 124, respectively. In this way, both the front portion 160 and the rear portion 162 of each of the front door assembly 130 and the rear door assembly 132 are mechanically connected to the body 110 of the vehicle 100.

By restricting movement of the front door assembly 130 with respect to the B-pillar 122 and/or the rear door assembly 132 with respect to the C-pillar 124, inboard intrusion of the front door assembly 130 and/or the rear door assembly 132 into the cabin 108 during the impact is restricted. By restricting intrusion of the front door assembly 130 and/or the rear door assembly 132 into the cabin 108 during the impact, energy and/or forces associated with the side impact may be absorbed and distributed throughout the body 110 of the vehicle 100 around the cabin 108.

It should now be understood that vehicles according to the present disclosure include door assemblies and vehicles including door assemblies. In embodiments, a door assembly includes a door outer panel, a door inner panel that is coupled to and positioned inboard of the door outer panel in a vehicle lateral direction, an impact beam positioned between the door outer panel and the door inner panel, and an engagement member coupled to the impact beam. The engagement member may include a shaft that extends through a hole defined by the impact beam and that extends in the vehicle lateral direction. The door assembly may be coupled to a forward pillar assembly and the engagement member is aligned with a pillar outer panel and a pillar inner panel of a rearward pillar assembly in a vehicle longitudinal direction. During a side impact, energy and/or forces associated with the impact cause the door outer panel, the door inner panel, and the engagement member to translate inboard in the vehicle lateral direction and cause the engagement member to pierce the door inner panel and the pillar outer panel. By piercing the pillar outer panel, the engagement member may impede intrusion of the door assembly into a passenger cabin of the vehicle during a side impact. Further, as the engagement member is initially positioned between the door outer panel and the door inner panel, the engagement member may not be visible from an exterior of the vehicle during ordinary vehicle operating conditions.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A door assembly comprising:
a door outer panel;
a door inner panel that is coupled to and positioned inboard of the door outer panel in a vehicle lateral direction;
a door impact beam positioned between the door outer panel and the door inner panel, wherein the door impact beam extends in a vehicle longitudinal direction; and
an engagement member coupled to the door impact beam, the engagement member comprising a shaft that extends through a hole defined by the door impact beam and that extends in the vehicle lateral direction toward the door inner panel.

2. The door assembly of claim 1, wherein the door impact beam is coupled to at least one of the door inner panel and the door outer panel.

3. The door assembly of claim 1, wherein the door impact beam comprises a central portion and an end portion positioned proximate to an end of the door impact beam, wherein the engagement member is coupled to the end portion of the door impact beam.

4. The door assembly of claim 3, wherein the central portion of the door impact beam comprises a central beam width evaluated in the vehicle lateral direction and the end portion of the door impact beam comprises an end beam width evaluated in the vehicle lateral direction, wherein the central beam width is greater than the end beam width.

5. The door assembly of claim 3, wherein the central portion of the door impact beam comprises a central beam height evaluated in a vehicle vertical direction and the end portion of the door impact beam comprises an end beam height evaluated in the vehicle vertical direction, wherein the end beam height is greater than the central beam height.

6. The door assembly of claim 1, wherein the door impact beam further comprises side flanges and a central flange that is spaced apart from the side flanges in the vehicle lateral direction.

7. The door assembly of claim 1, wherein the door impact beam comprises an enclosed cross-section.

8. A vehicle comprising:
a body comprising a forward pillar assembly and a rearward pillar assembly, wherein at least one of the forward pillar assembly and the rearward pillar assembly comprises:
a pillar outer panel;
a pillar inner panel coupled to and positioned inboard of the pillar outer panel in a vehicle lateral direction;
a door assembly coupled to the forward pillar assembly, the door assembly comprising:
a door outer panel;
a door inner panel that is coupled to and positioned inboard of the door outer panel in the vehicle lateral direction; and
an engagement member is positioned between the door inner panel and the door outer panel, wherein the engagement member is aligned with the pillar outer panel and the pillar inner panel in the vehicle longitudinal direction and at least a portion of the engagement member extends in the vehicle lateral direction toward the door inner panel.

9. The vehicle of claim 8, wherein the engagement member is coupled to a door impact beam that is coupled to at least one of the door inner panel and the door outer panel.

10. The vehicle of claim 9, wherein the engagement member comprises a shaft that extends through a hole defined by the door impact beam, wherein the shaft extends in the vehicle lateral direction.

11. The vehicle of claim 9, wherein the door impact beam comprises a central portion and an end portion positioned proximate to an end of the door impact beam, wherein the engagement member is coupled to the end portion of the door impact beam.

12. The vehicle of claim 11, wherein the central portion of the door impact beam comprises a central beam width evaluated in the vehicle lateral direction and the end portion of the door impact beam comprises an end beam width evaluated in the vehicle lateral direction, wherein the central beam width is greater than the end beam width.

13. The vehicle of claim 11, wherein the central portion of the door impact beam comprises a central beam height evaluated in a vehicle vertical direction and the end portion of the door impact beam comprises an end beam height evaluated in the vehicle vertical direction, wherein the end beam height is greater than the central beam height.

14. The vehicle of claim 9, wherein the door impact beam further comprises side flanges and a central flange that is spaced apart from the side flanges in the vehicle lateral direction.

15. The vehicle of claim 9, wherein the door impact beam comprises an enclosed cross-section.

16. The vehicle of claim 8, wherein the pillar inner panel comprises a reduced thickness region.

17. The vehicle of claim 16, wherein the reduced thickness region comprises an aperture through the pillar inner panel.

18. The vehicle of claim 16, wherein the engagement member is aligned with the reduced thickness region in a vehicle longitudinal direction.

19. A method of inhibiting movement of a door assembly with respect to a rearward pillar assembly, the method comprising:
providing an engagement member positioned between a door outer panel and a door inner panel in a vehicle lateral direction; and
positioning the engagement member such that when the engagement member translates inboard in the vehicle lateral direction, the engagement member pierces the door inner panel and a pillar outer panel.

20. The method of claim 19, further comprising positioning the engagement member such that when the engagement member translates inboard in the vehicle lateral direction, the engagement member pierces a reduced thickness region of a pillar inner panel.
